(19) United States
(12) Patent Application Publication
(10) Pub. No.: US 2011/0175918 A1
(43) Pub. Date: Jul. 21, 2011

(54) CHARACTER ANIMATION CONTROL INTERFACE USING MOTION CAPURE

(76) Inventors: Cheng-Yun Karen Liu, Decatur, GA (US); Satoru Ishigaki, Tokyo (JP)

(21) Appl. No.: 12/691,220

(22) Filed: Jan. 21, 2010

(51) Int. Cl. G06T 13/00

(52) U.S. Cl. 345/473

(57) ABSTRACT

A processor-readable medium stores code representing instructions to cause a processor to define a virtual feature. The virtual feature can be associated with at least one engaging condition. The code further represents instructions to cause the processor to receive an end-effector coordinate associated with an actor and calculate an actor intention based at least in part on a comparison between the at least one engaging condition and the end-effector coordinate.

### CROSS-REFERENCE TO RELATED APPLICATION

The present application claims priority to U.S. provisional application no. 61/461,154 entitled “Character Animation Control Interface Using Motion Capture,” filed on Jan. 21, 2009, which is hereby incorporated by reference herein.

### BACKGROUND

Embodiments described herein relate generally to motion capture and computer animation technology, and more particularly to methods and apparatus for the generation of a virtual character based at least in part on the movements of a real-world actor.

Video capture devices often record the motion of an individual in the real world and use the gathered information to simulate that individual's motion in a virtual environment. This technique can be used for a variety of purposes, many of which involve computer graphics and/or computer animation. For example, commercial entities often use known motion capture techniques to first record and then virtually reproduce the movements of a well-known individual, such as an athlete, in a computer or video game. The generated virtual representation of real-world movements is thus familiar to the video game's target market and can accordingly improve a user's perception of game authenticity.

Because it is acquired at a first time and stored for rendering at a later time, such data is often labeled “offline data”. Offline data typically contains more precise measurements of an actor's movement, thus allowing a rendering system to more accurately depict the movement in a virtual world. However, such data is also limited to the specific actor movements and poses gathered during the preliminary capture session, thus constraining such a system from rendering any of the other myriad possible poses that it might be desirable to depict.

In other methods, the real-world positions and movements of an actor are mapped into virtual space in near real-time, affording the actor finer control over the movements of the corresponding virtual character and a theoretically infinite number of possible virtual positions. The data gathered using such methods is termed “online data”, and the immediacy of its capture allows the actor to “interact” with elements of the virtual space or world. However, given the time constraints and processing demands of such methods, online data is often less accurate than its offline counterpart, particularly when the relevant virtual world is substantially different from the actor's particular real-world environment.

Thus, a need exists for systems and apparatus capable of gathering online motion capture data, discerning an actor intention based thereupon, and accurately rendering actor motion subject to the constraints of a virtual world.

### SUMMARY

A processor-readable medium stores code representing instructions to cause a processor to define a virtual feature. The virtual feature can be associated with at least one engaging condition. The code further represents instructions to cause the processor to receive an end-effector coordinate associated with an actor and calculate an actor intention based at least in part on a comparison between the at least one engaging condition and the end-effector coordinate.

### BRIEF DESCRIPTION OF THE DRAWINGS

FIG. 1 is a schematic illustration of a motion capture and pose calculator system, according to an embodiment.

FIG. 2 is a schematic block diagram that shows a virtual pose calculator module, according to an embodiment.

FIG. 3 is a schematic block diagram that shows an intention recognition module, according to an embodiment.

FIG. 4 is a flowchart that illustrates a method for calculating an intermediate virtual pose associated with a real-world actor and a virtual character, according to an embodiment.

FIG. 5 is a flowchart that illustrates a method for determining a new virtual character center of mass, according to an embodiment.

FIG. 6 is a flowchart that illustrates a method for calculating a final pose that avoids penetrated geometries, according to an embodiment.

### DETAILED DESCRIPTION

A virtual pose calculation module can be configured to receive information associated with the spatial positions of end-effector markers coupled to a real-world actor such as a human being. In some embodiments, the module can map the real-world end-effector markers into a virtual world to render a virtual character based on the actor. The module can be configured so as to minimize discrepancies between the poses and motion of the actor and those of the corresponding virtual character. In some embodiments, module can be configured to enforce one or more constraints associated with a virtual world to ensure that the rendered virtual character moves in a manner consistent with its virtual surroundings.

In some embodiments, the module can define one or more virtual features that exist within a virtual world. The virtual features can be defined to include set of position coordinates, dimensions, and contact constraints, and/or a surface type. In some embodiments, one or more example motions can be defined and associated with each virtual feature. In some embodiments, the virtual pose calculation module can include one or more submodules configured to determine an intention of a real-world actor relative to one or more of the virtual features. The determination can be based on, for example, the positions of end-effectors coupled to the real-world actor and/or the set of contact constraints associated with each virtual feature. In some embodiments, the module can include a submodule that determines if the actor's current pose mimics one of the set of example motions associated with that virtual feature. The determination can be based on, for example, a measure of similarity between the positions of real-world actor end-effectors and the positions of virtual end-effectors defined by the example motion.

In some embodiments, the module can calculate an intermediate virtual pose for the virtual character based on the real-world actor's position and/or movement. For example, in some embodiments, the module can include one or more submodules configured to construct the intermediate virtual pose by cycling through each actor end-effector and calculating an intermediate virtual end-effector position corresponding to that actor end-effector.

For example, in some embodiments, the submodule can assign the value of the intermediate virtual pose end-effector to the position of the corresponding actor end-effector if the actor end-effector is unconstrained and/or the corresponding virtual character end-effector is constrained. The submodule can also assign the value of the intermediate virtual pose end-effector to a value calculated based on an interpolation between the corresponding example motion end-effector position and the actor end-effector position if both the corresponding virtual end-effector is unconstrained and the corresponding actor end-effector is constrained. In some embodiments, each intermediate virtual pose end-effector position calculation can be further weighted and/or influenced based on one or more additional factors or goals, such as consistency with a previous virtual character pose, similarity with the example motion, and consistency with the actor's overall motion.

The pose calculation module can be further configured to calculate a next center of mass for the virtual character. For example, in some embodiments the pose calculation module can include a submodule that calculates a next virtual center of mass based at least in part on a spring force associated with at least one virtual end-effector of a virtual character. In some embodiments, the calculation can be based at least in part on a frictional force associated with one or more constrained virtual end-effectors of the virtual character. In some embodiments, the calculation can be based at least in part on a simulated gravitational force exerted on the virtual character.

The pose calculation module can be further configured to combine an intermediate virtual pose and a new virtual center of mass (or “COM”) to determine a new virtual pose for the virtual character. For example, in some embodiments, the module can include one or more submodules configured to combine the virtual end-effector position values associated with the intermediate virtual pose with the new virtual COM to define the new pose. In some embodiments, the submodule can cycle through a set of interactive contact points associated with each virtual feature in contact with the new virtual pose to determine if any end-effector of the new virtual pose penetrates the surface of any virtual feature. If the submodule detects any such penetration, in some embodiments it can insert an inequality constraint for each penetrated geometry to the original new pose calculation formula so as to calculate a modified new pose that conforms to the contact constraints of each virtual feature and thus avoids any penetrated geometries.

In some embodiments, the pose calculation module can send information associated with the new pose to another hardware- and/or software-based module such as a video game software module. In some embodiments, the module can send the information to a display device, such as a screen, for display of a virtual character rendered according to the new pose. By performing the above-described steps and outputting a rendered virtual character according to each successive new pose calculated over time, the module can generate an accurate visual rendering of real-world actor motion in virtual space.

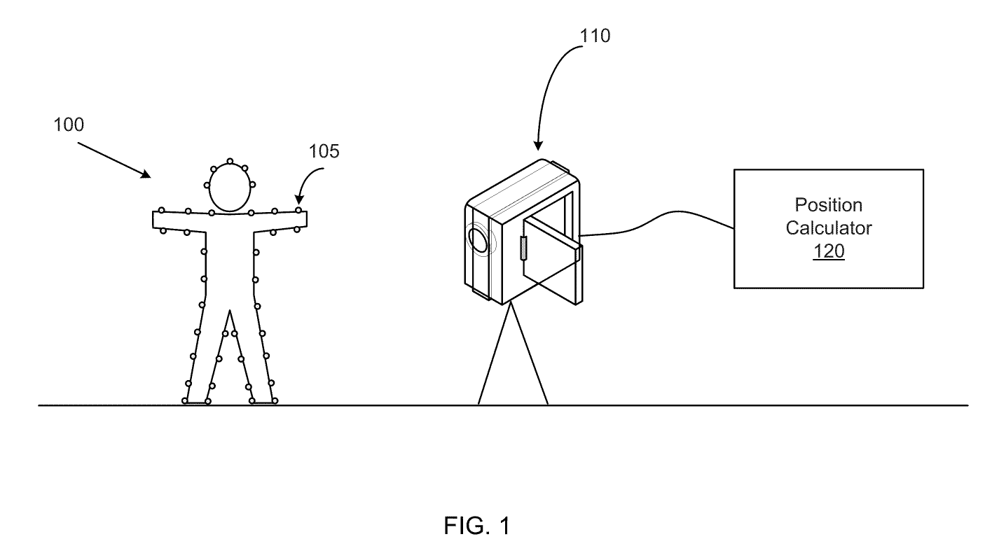

FIG. 1 is a schematic illustration of a motion capture and pose calculator system, according to an embodiment. More specifically, FIG. 1 illustrates an actor 100 wearing a plurality of markers 105. Based at least in part on the plurality of markers 105, the movements of the actor 100 are tracked by a capture device 110 and mapped into a virtual context by a pose calculator 120. The capture device 110 is operatively coupled to the pose calculator 120. In some embodiments, the pose calculator 120 can be operatively coupled to an integrated and/or external video display (not shown).

The actor 100 can be any real-world object, including, for example, a human being. In some embodiments, the actor 100 can be in motion. In some embodiments, the actor 100 can be clothed in special clothing sensitive to the capture device 110 and/or fitted with one or more markers sensitive to the capture device 110, such as the plurality of markers 105. In some embodiments, at least a portion of the markers 105 are associated with one or more actor end-effectors. In some embodiments, the actor 100 can be an animal, a mobile machine, a vehicle, or a robot.

The plurality of markers 105 can be any plurality of marker devices configured to allow tracking of movement by a capture device, such as the capture device 110. In some embodiments, the plurality of markers 105 can include one or more retro-reflective markers. In some embodiments, at least a portion of the plurality of markers 105 can be coupled or adhered to one or more articles of clothing, such as pants, a shirt, a bodysuit, and/or a hat or cap.

The capture device 110 can be any combination of hardware and/or software capable of capturing video. In some embodiments, the capture device 110 can be capable of detecting the spatial positions of one or more markers, such as the plurality of markers 105. In some embodiments, capture device 110 can be a dedicated video camera or a video camera coupled to or integrated within a consumer electronics device such as a personal computer, cellular telephone, or other device. In some embodiments, the capture device 110 can be a hardware-based module (e.g., a processor, an application-specific integrated circuit (ASIC), a field programmable gate array (FPGA)). In some embodiments, the capture device 110 can be a software-based module residing on a hardware device (e.g., a processor) or in a memory (e.g., a RAM, a ROM, a hard disk drive, an optical drive, other removable media) operatively coupled to a processor.

In some embodiments, the capture device 110 can be physically coupled to a stabilization device such as a tripod or monopod, as shown in FIG. 1. In some embodiments, the capture device 110 can be held and/or stabilized by a camera operator (not shown). In some embodiments, the capture device 110 can be in motion. In some embodiments, the capture device 110 can be physically coupled to a vehicle. In some embodiments, the capture device 110 can be physically and/or operatively coupled to the pose calculator 120. For example, the capture device 110 can be coupled to the pose calculator 120 via a wire and/or cable (as shown in FIG. 1). In some embodiments, the capture device 110 can be wirelessly coupled to the pose calculator 120 via one or more wireless protocols such as Bluetooth, Ultra Wide-band (UWB), wireless Universal Serial Bus (wireless USB), microwave, WiFi, WiMax, one or more cellular network protocols such as GSM, CDMA, LTE, etc.

The pose calculator 120 can be any combination of hardware and/or software capable of calculating a virtual pose and/or position associated with the actor 100 based at least in part on information received from the capture device 110. In some embodiments, the pose calculator 120 can be a hardware computing device including a processor, a memory, and firmware and/or software configured to cause the processor to calculate the actor pose and/or position. In some embodiments, the pose calculator 120 can be any other hardware-based module, such as, for example, an application-specific integrated circuit (ASIC) or a field programmable gate array (FPGA). The pose calculator 120 can alternatively be a software-based module residing on a hardware device (e.g., a processor) or in a memory (e.g., a RAM, a ROM, a hard disk drive, an optical drive, other removable media) operatively coupled to a processor.

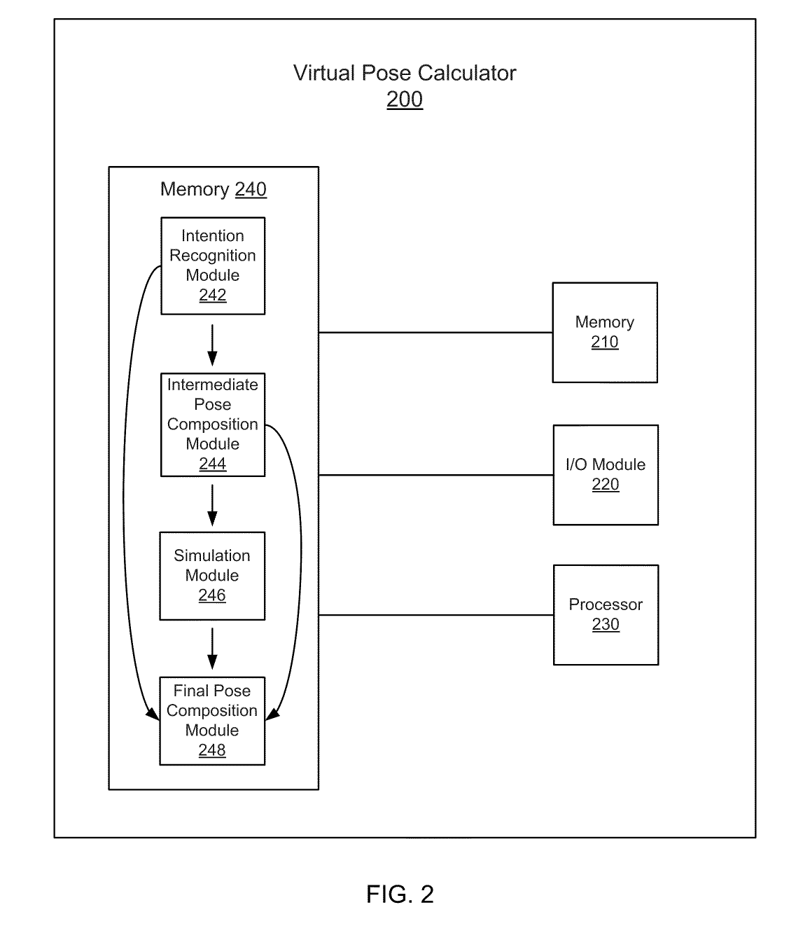

FIG. 2 is a schematic block diagram that shows a virtual pose calculator, according to an embodiment. More specifically, FIG. 2 illustrates a virtual pose calculator 200 that includes a first memory 210, an input/output (I/O) module 220, a processor 230, and a second memory 240 that includes an intention recognition module 242, an intermediate pose composition module 244, a simulation module 246 and a final pose composition module 248. Intention recognition module 242 can receive motion capture information from I/O module 220 and send intention, motion capture and/or example motion information to the intermediate pose composition module 244. Intermediate pose composition module 244 can receive intention, motion capture and/or example motion information from the intention recognition module 242 and send intermediate pose information to simulation module 246. Simulation module 246 can receive intermediate pose information from intermediate pose composition module 244 and send new center of mass (“COM”) information and/or contact constraint information associated with a virtual feature to final pose composition module 248. Final pose composition module 248 can receive contact constraint information from the intention recognition 242 and/or the simulation module 246. In some embodiments, the final pose composition module can receive new center of mass information and/or intermediate pose information from the simulation module 246. In some embodiments, the final pose composition module can receive intermediate pose information from the intermediate pose composition module 244.

In some embodiments, the final pose composition module 248 can and send final pose information to I/O module 220. In some embodiments, I/O module 220 can be configured to send at least a portion of the final pose information to an output display, such as a monitor or screen (not shown). In some embodiments, I/O module 220 can send at least a portion of the final pose information to one or more hardware and/or software modules, such as a video game module or other computerized application module.

In some embodiments, the first memory 210, the I/O module 220, the processor 230 and the second memory 240 can be connected by, for example, one or more integrated circuits. Although shown as being within a single location and/or device, in some embodiments, any of the two memory modules, I/O module, and processor 230 an be connected over a network, such as a local area network, wide area network, or the Internet.

First memory 210 and second memory 240 can be any type of memory such as, for example, a read-only memory (ROM) or a random-access memory (RAM). In some embodiments, the first memory 210 and/or the second memory 240 can be, for example, any type of computer-readable media, such as a hard-disk drive, a compact disc read-only memory (CD-ROM), a digital video disc (DVD), a Blu-ray disc, a flash memory card, or other portable digital memory type. The first memory 210 can be configured to send signals to and receive signals from the second memory 240, the I/O module 220 and the processor 230. The second memory 240 can be configured to send signals to and receive signals from the first memory 210, the I/O module 220 and the processor 230.

I/O module 220 can be any combination of hardware and/or software configured to receive information into and send information from the virtual pose calculator 200. In some embodiments, the I/O module 220 can receive information from a capture device (such as the capture device discussed in connection with FIG. 1 above) that includes video and/or motion capture information. In some embodiments, I/O module 220 can send information to another hardware and/or software module or device such as an output display, other computerized device, video game console or game module, etc.

Processor 230 can be any processor or microprocessor configured to send and receive information, send and receive one or more electrical signals, and process and/or generate instructions. In some embodiments, the processor 230 can include firmware and/or one or more pipelines, busses, etc. In some embodiments, the processor could be, for example, a digital signal processor (DSP) a field-programmable gate array (FPGA), an application-specific integrated circuit (ASIC), etc. In some embodiments, the processor can be an embedded processor and can be and/or include one or more co-processors.

The intention recognition module 242 can be any combination of hardware and/or software capable of receiving motion capture data and determining an actor intention based thereon. As shown in FIG. 2, intention recognition module 242 can be a software module residing in second memory 240. In some embodiments, the intention recognition module 242 can include information associated with one or more virtual features of a virtual world, space, context or setting (not shown). For example, in some embodiments, the intention recognition module 242 can include information associated with one or more virtual features, such as furniture, equipment, projectiles, other virtual characters, structural components such as floors, walls and ceilings, etc.

In some embodiments, the intention recognition module 242 can include a set of engaging conditions, contact constraints and/or one or more example motions associated with each virtual feature of a virtual world. In some embodiments, each set of engaging conditions can, when satisfied, indicate that an actor is intending to interact with an associated virtual feature. In some embodiments, each set of engaging conditions can include a set of spatial coordinates associated with a virtual feature that, when occupied by an actor, indicate that the actor intends to interact with that virtual feature. In such embodiments, the intention recognition module 242 can determine if the actor intends to interact with any of the defined virtual features based on the set of engaging conditions associated with each.

In some embodiments, the intention recognition module 242 can determine if an actor is mimicking an example motion associated with a virtual feature. For example, if intention recognition module 242 has determined that the actor has satisfied one or more engaging conditions associated with that virtual feature, the module can compare one or more positions and/or velocities associated with an actor to determine if the actor's current pose closely matches a stored example motion associated with that virtual feature. In some embodiments, the intention recognition module 242 can send information associated with the determination to the intermediate pose composition module 244. In some embodiments, the intention recognition module 244 can additionally send to the pose composition module 240 one or more of: motion capture data associated with the actor, a set of engaging conditions associated with a virtual feature, and the definition of an example motion associated with the virtual feature. In some embodiments, the intention recognition module 244 can send a set of contact constraints associated with the virtual feature to the final pose composition module 248.

The intermediate pose composition module 244 can be any combination of hardware and/or software capable of composing an intermediate virtual pose based at least in part on actor motion capture information and an example motion associated with a virtual feature. As shown in FIG. 2, pose composition module 244 can be a software module residing in second memory 240. In some embodiments, the pose composition module 244 can use the motion capture data and example motion information associated with a virtual feature to calculate an integrated pose that describes the pose of a real-world actor in a virtual world.

For example, in some embodiments, the pose composition module 244 can receive information associated with one or more motion markers that define the position of a real-world actor and the definition of an example motion associated with a virtual feature. In some embodiments, the motion marker information can indicate the spatial positions of one or more end-effectors adhered to or associated with the actor. In some embodiments, the defined example motion can indicate the spatial positions of one or more end points of an example motion that can be performed with, on, or about a virtual feature. In such embodiments, the pose composition module 244 can use the received information to intelligently and adaptively calculate an integrated virtual pose for the actor that closely resembles the actor's real-world pose. In some embodiments, the pose composition module 244 can send at least a portion of the integrated pose information to the simulation module 246 and/or final pose composition module 248.

The simulation module 246 can be any combination of hardware and/or software capable of calculating a new simulated center of mass for a virtual character based on an intermediate virtual pose and the virtual character's current pose. As shown in FIG. 2, simulation module 246 can be a software module residing in second memory 240. In some embodiments, the simulation module 246 can use the intermediate pose information calculated by the pose composition module 244 and information defining the virtual character's current pose to calculate a new center of mass of the virtual character. In some embodiments, the simulation module 246 can send at least a portion of the new center of mass information to the final pose composition module 248.

The final pose composition module 248 can be any combination of hardware and/or software capable of calculating a final virtual character pose based at least in part on the virtual character's current pose, a simulated new center of mass for the virtual character, and a set of contact constraints associated with a virtual feature currently being engaged by the virtual character. In some embodiments, the final pose composition module 248 can receive any of: intention information, example motion information, virtual feature information, contact constraint information, intermediate pose information, and/or new center of mass information from any of intention recognition module 242, intermediate pose composition module 244, and simulation module 246.

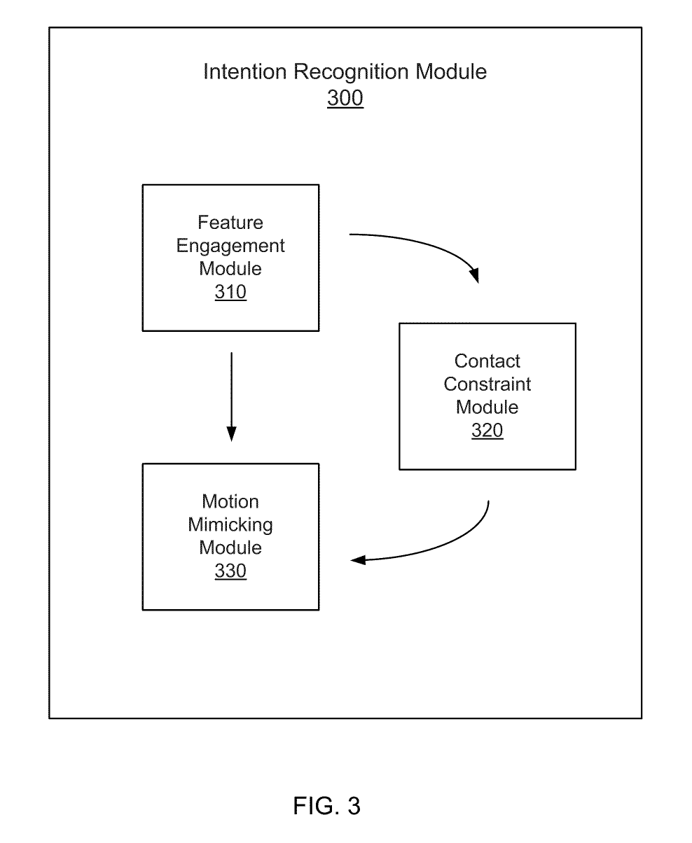

FIG. 3 is a schematic block diagram that shows an intention recognition module, according to an embodiment. More specifically, FIG. 3 illustrates an intention recognition module 300 that includes a feature engagement module 310, a contact constraint module 320 and a motion mimicking module 330. In some embodiments, the feature engagement module 310 can send one or more signals to contact constraint module 320. In some embodiments, the contact constraint module 320 can send one or more signals to the motion mimicking module 330.

In some embodiments, the intention recognition module 300 can include one or more hardware and/or software modules configured to receive and send signals including information to and from the module. In some embodiments, the intention recognition module 300 can be a software module stored in a memory of a computerized device configured to process motion capture information. In some embodiments, the intention recognition module 300 can be a separate hardware device operatively coupled to one or more other hardware devices for purposes of processing motion capture information and/or calculating properties of a virtual character.

In some embodiments, the intention recognition module 300 can calculate whether a virtual character is attempting to interact with one or more virtual features and/or objects. For example, in some embodiments, the intention recognition module 300 can receive motion capture information based on a current position and/or movement of a real-world actor, such as a human, and use the information to determine if the actor is attempting to interact with a virtual door, chair, or book. In some embodiments, if the intention recognition module 300 determines that the actor is attempting to interact with a given virtual feature, it can then compare the actor's current real-world pose to each of a predefined set of example motions associated with that virtual feature to determine if the actor is currently mimicking any of them. In some embodiments, the intention recognition module 300 can then send the example motion information and current actor real-world pose information to another module (such as the intermediate pose calculator module discussed in connection with FIG. 2 above) for calculation of an intermediate virtual character pose based on the sent information.

Feature engagement module 310 can be any combination of hardware and/or software configured to receive current actor pose information and determine whether the actor is attempting to engage with any particular virtual feature in a virtual world. More specifically, in some embodiments, the feature engagement module 310 can first receive information that defines an actor's real-world pose and/or position. In some embodiments, the information can be detected, gathered, and/or received by a capture or other device operatively or physically coupled to the intention recognition module. In some embodiments, the pose and/or position information can comprise one or more spatial coordinates of one or more end-effectors of the actor. For example, in some embodiments, the pose information can include a series of x, y and z or r, θ, and φ coordinate sets, each associated with an actor end-effector such as a marker or other physical end-effector. In some embodiments, each end-effector can be physically positioned on an actor body point, such as an elbow, a hand, or another exterior portion of the body.

In some embodiments, the feature engagement module 310 can include information associated with one or more virtual features the virtual world. For example, in some embodiments the virtual feature information can include color, spatial position, spatial dimension, mass, surface area, volume, rigidity, malleability, friction, surface type and/or other properties of a virtual feature. In some embodiments, the feature engagement module 310 can include a set of engaging conditions associated with each virtual feature. The engaging conditions can include, for example, a set of spatial coordinates that, if occupied by a real-world actor (i.e., closely mapped by the actor's current end-effector positions), indicate that the actor is currently attempting to “engage”, or interact with, that virtual feature.

In some embodiments, the feature engagement module 310 can cycle through each virtual feature in a current virtual world and determine if the actor is currently engaging that virtual feature. For example, in some embodiments the feature engagement module 310 can, for each virtual feature, compare that virtual feature's associated engaging conditions with the current spatial positions of the actor's end-effectors. If the actor's current pose meets the engaging conditions associated with a given virtual feature, the feature engagement module 310 can define an engagement indicator variable indicating that the actor is currently engaging that particular virtual feature. In some embodiments, the feature engagement module 310 can determine if the actor's current position meets a given virtual feature's engaging conditions based on whether the difference, or Δ, between the actor's end-effector positions and the virtual feature's spatial position and dimensions is below a predetermined threshold. If the feature engagement module 310 does in fact set an indicator value indicating that the actor is currently engaging a particular virtual feature, it can send the engagement indicator, an identifier associated with the virtual feature, and the actor's end-effector position information to the contact constraint module 320. In some embodiments, the feature engagement module 310 can alternatively or additionally send an identifier associated with the particular virtual feature and the actor end-effector positions to the motion mimicking module 330.

In some embodiments, the contact constraint module 320 can receive a virtual feature identifier, a set of actor end-effector positions, and an engagement indicator from the feature engagement module 310. In some embodiments, the engagement indicator can contain a binary value, such as “yes”, “no”, 1, 0, or information that identifies a virtual feature currently being engaged by the actor. In some embodiments, the contact constraint module 320 can calculate a set of contact constraints, or interactive contact points, associated with the identified virtual feature. The contact constraints can be, for example, a set of points that define the position, dimensions, edges, and/or surface of an associated virtual feature. In some embodiments, the contact constraints module 320 can then send at least one of the calculated contact constraints, virtual feature identifier and actor end-effector spatial coordinates to the motion mimicking module 330.

Motion mimicking module 330 can be any combination of hardware and/or software configured to determine if a real-world actor, such as a human actor, is currently mimicking a predefined example motion associated with a virtual feature. As shown in FIG. 3, the motion mimicking module 330 can be a software module storing instructions configured to cause a processor to execute one or more steps that perform the above actions.

In some embodiments, the motion mimicking module 330 can receive actor pose information, such as actor end-effector position information, a virtual feature identifier, and/or an engagement indicator from one or more of feature engagement module 310 and contact constraint module 320. In some embodiments, the motion mimicking module 330 can receive any of the above from another hardware and/or software module, or other hardware or computerized device.

In some embodiments, the motion mimicking module 330 can determine whether the actor is currently mimicking any of a set of predefined example motions associated with the virtual feature that the actor is currently engaging. For example, in some embodiments, the module can cycle through each example motion associated with the engaged virtual feature, and for each, cycle through each actor end-effector to determine if the spatial position of that actor end-effector matches (or matches within an acceptable margin of error) the spatial position of a corresponding virtual end-effector defined by that example motion. In some embodiments, the module can additionally compare a velocity of that actor end-effector with the velocity of the corresponding virtual end-effector defined by the example motion. In some embodiments, the module can be configured to only consider actor end-effectors that are currently “unconstrained”, i.e. currently not in direct contact with another physical mass or object. For example, in such embodiments, an actor standing up straight on a floor with hands to the side can be considered to have constrained end-effectors on the feet (which are currently in contact with the floor), but unconstrained end-effectors on the hands (which are currently dangling in the air, acted upon only by gravity).

In some embodiments, the above comparison process can be executed in reduced- or low-dimensional space so as to simplify the necessary calculations. In some embodiments, the motion mimicking module 330 can use principal component analysis (PCA) as part of the process described above.

In some embodiments, the comparison can be made holistically on an entire example motion and set of actor end-effectors. In other words, a running error or discrepancy total can be kept throughout each end-effector comparison for a given example motion. Once all end-effectors for the example motion currently under consideration have been compared, in some embodiments the motion mimicking module 330 can compare the total error for that example motion with a predetermined threshold. If, for example, the total error for the current example motion fails to exceed the predetermined threshold, the actor's current real-world pose and the example motion can be considered sufficiently similar for the mimicking module 330 to conclude that the actor is currently mimicking that example motion associated with the engaged virtual feature.

In some embodiments, the above comparisons between sets of actor end-effector coordinates and sets of predefined virtual end-effector coordinates can include comparison of only subsets of the two end-effector sets. For example, in some embodiments, the comparisons can be made on only a subset of core or bellwether end-effectors that are sufficient to indicate an actor's overall intention and/or general pose.

In some embodiments, once the motion mimicking module 330 has completed the above comparisons, it can send one or more signals to another module within the intention recognition module 300 and/or an external hardware and/or software module including at least one of: an engagement indicator, an example motion indicator or identifier, a mimicked example motion definition (if applicable), and/or the actor end-effector coordinates.

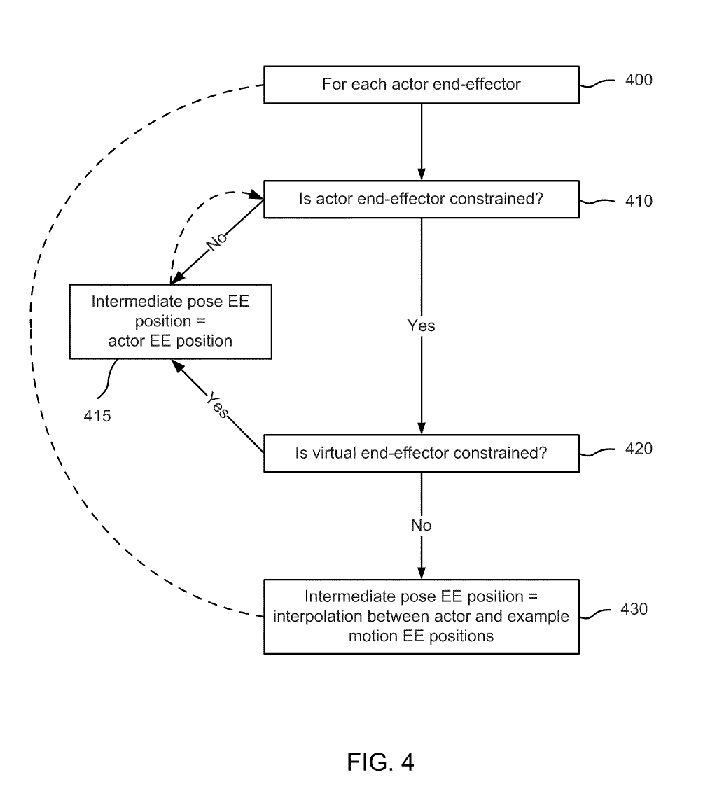

FIG. 4 is a flowchart that illustrates a method for calculating an intermediate virtual pose associated with a virtual character, according to an embodiment. More specifically, FIG. 4 illustrates a series of steps that can be executed by a device to calculate an intermediate virtual pose based on an example motion associated with a virtual feature and a current real-world actor pose. When executed, the steps can calculate a position in virtual space (i.e., an intermediate virtual end-effector) corresponding to each of a series of end-effectors associated with a current real-world actor position as detected by a motion capture system. In some embodiments, each step can be performed by any combination of hardware and/or software, such as one or more computerized devices. Such a device will be discussed for purposes of explanation below.

As shown in FIG. 4, steps 410 through 430 can be performed for each of a set of actor end-effectors, 400. As such, the discussion of each step 410-430 below will discuss execution of that step for a single actor end-effector. However, it should be understood that in some embodiments the computerized device can execute the steps 410-430 at least once for each actor end-effector from the set of actor end-effectors associated with the real-world actor, thereby calculating a complete intermediate virtual pose.

In some embodiments, the actor end-effectors can be a set of one or more actor body end points or reflective markers positioned in real space, with each position being represented by one or more spatial coordinates. For example, in some embodiments the position of each actor end-effector can be represented by a set of x, y and z or r, θ, and φ coordinates. In some embodiments, each actor end-effector position can be determined by a video capture device and a computerized hardware and/or software device coupled thereto.

A computerized device can determine whether an actor end-effector is constrained, at 410. In some embodiments, the computerized device can receive the actor end-effector position from an I/O module or an intention module similar to the I/O and intention modules discussed in connection with FIG. 2 above. In some embodiments, the device can determine if the end-effector's position indicates that it is currently in contact with an external surface. For example, in some embodiments, the end-effector can be positioned on an actor's foot, and the computerized device can determine that the end-effector is currently in contact with a surface, such as a floor.

The computerized device can next execute one of two instructions based on the above-determined constraint state of the actor end-effector. If the actor end-effector is currently unconstrained, the device can set the position of the corresponding intermediate pose end-effector to that of the current actor end-effector. For example, in some embodiments, if the actor end-effector is determined to be unconstrained in step 400 and has a position defined by coordinates (x₁, y₁, z₁), the device can assign the corresponding end-effector value for the intermediate virtual pose to (x₁, y₁, z₁). At that point, the device can iterate and/or proceed to consider a next actor end-effector and return to step 410 described above. Alternatively if the actor end-effector from step 410 is currently constrained, the device can proceed to step 420.

The computerized device can determine if the virtual character end-effector corresponding to the actor end-effector is constrained, 420. In some embodiments, the device can compare the position of the virtual character end-effector corresponding to the actor end-effector to that of one or more virtual features to determine if the virtual end-effector is positioned sufficiently close to the feature to be constrained. If the device determines that the virtual end-effector is constrained, it can proceed to step 415 described above and continue processing based on the current actor end-effector and corresponding virtual end-effector. If the device determines that the actor end-effector is not currently constrained, it can proceed to step 430 described below.

The computerized device can calculate the position of the intermediate virtual end-effector corresponding to the actor end-effector, 430. The calculation can be based on, for example, an interpolation calculation between the actor end-effector and the corresponding virtual character end-effector positions. For example, in some embodiments the interpolation calculation can include an averaging calculation based on the positions of both the actor and corresponding example motion end-effectors. Such an interpolation can be advantageous inasmuch as it effects a compromise between the real-world movement of the actor and the virtual-world-specific example motion.

In some embodiments, the calculation can include and/or be influenced by one or more weighting factors. In some embodiments, the one or more weighting factors can be configured to preserve similarity of the calculated intermediate virtual pose to the example pose associated with the engaged virtual feature. In some embodiments, at least one weighting factor can be configured to minimize differences between the calculated intermediate virtual pose and a previous pose of the virtual character. In some embodiments, at least one weighting factor can be configured to preserve and/or follow motion of the actor. After calculating the intermediate virtual end-effector position, the device can iterate and/or proceed to consider a next actor end-effector as discussed above.

In some embodiments, the computerized device can execute the above instructions on each of at least a portion of a set of actor end-effectors so as to, in the aggregate, compute an intermediate virtual pose comprised of individual virtual end-effector values. In some embodiments, the set of actor end-effectors can be a subset of all the possible actor end-effectors associated with a real-world actor. In some embodiments, the set of actor end-effectors can be comprised of a minimal number of end-effectors, such as five. In such embodiments, the minimal number of actor end-effectors can be located on core portions of the actor's body so as to maximize the degree to which their movement is representative of the actor's as a whole.

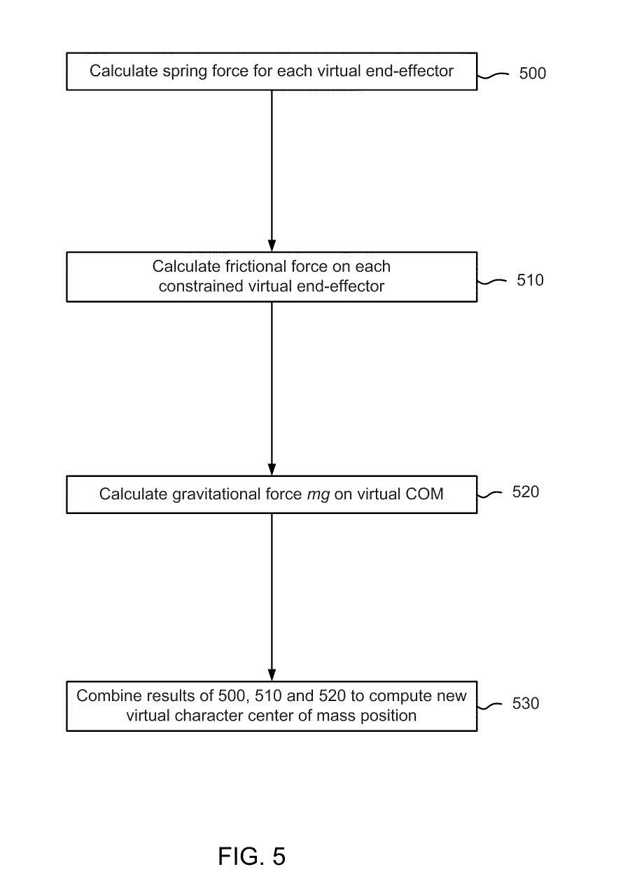

FIG. 5 is a flowchart that illustrates a method for determining a new virtual character center of mass (“COM”), according to an embodiment. More specifically, FIG. 5 illustrates a series of steps that can be executed by a device to calculate a new virtual character COM based at least in part on a calculated intermediate virtual pose, sets of real-world actor end-effector positions and contact types, and one or more surface types associated with one or more constrained virtual character end-effectors. In some embodiments, a computerized device or module can receive the above information from a hardware and/or software module that calculates an intermediate virtual pose, using, for example, a method similar to that discussed in connection with FIG. 4 above. In some embodiments, each step of the process described in FIG. 5 can be performed by any combination of hardware and/or software, such as one or more computerized devices. Such a device will be discussed for purposes of explanation below.

For purposes of the below discussion of FIG. 5, a possible virtual character simulation method is now defined. In some embodiments, a computerized device can define a virtual character to simulate a real-world actor's body and movement using a spring model. For example, in some embodiments the virtual character can be defined by a center-of-mass point and four damped “springs” that each approximate a human limb. In some embodiments, the center-of-mass point can be a point in virtual space defined by one or more coordinates, such as spatial coordinates in the form (x, y, z), (r, θ, and φ), etc. The center-of-mass point can be considered to be separately “attached” to each of the four damped “springs” and can be referred to simply as a “center of mass” or “COM”. In some embodiments, the virtual character defined by the above features can be supported against gravity by a sum of spring forces exerted by each virtual end-effector of the virtual character, a sum of frictional forces operating on constrained end-effectors of the virtual character, and the simulated gravitational force operating on the virtual COM.

A computerized device can calculate a spring force exerted by each of the virtual character's end-effectors, 500. More specifically, the device can calculate the spring force exerted by each virtual end-effector based at least in part on a relative distance between a COM and the spatial position of that end-effector in the virtual world. For example, in some embodiments, the device can calculate the spring force exerted by a given virtual end-effector at the current time by calculating the difference between the distance between the current virtual COM and that end-effector and the distance between the current real-world actor COM and the corresponding real-world end-effector. This difference can indicate the amount of virtual space that the virtual character's simulated limb must move relative to the virtual COM to properly simulate the movement of the real-world actor end-effector. In some embodiments, this spring force calculation can be further based at least in part on one or more predefined spring coefficients. In some embodiments, the spring force calculation can include a gravity factor configured to compensate for the effect of simulated gravity on each constrained end-effector of the virtual character. In some embodiments, the gravity factor can be configured to equally distribute the gravitational force across all end-effectors of the virtual character.

The device can calculate the frictional force acting on each constrained virtual end-effector, 510. More specifically, the device can calculate the frictional force exerted on each virtual end-effector currently in contact with an external virtual feature or surface. For example, in some embodiments, the device can cycle through each virtual end-effector and determine if that end-effector is constrained, by, for example, comparing the position of that end-effector with the spatial coordinates of one or more virtual features of the virtual world. If the given end-effector is constrained, the device can calculate a distance between the current virtual COM and the current actor real-world COM to determine a magnitude and/or direction of necessary movement (or “shift”) necessary to “move” the virtual COM to a position that matches the real-world COM. In some embodiments, the device can use this distance, along with a virtual end-effector type and/or a virtual feature surface type to calculate the frictional force currently experienced by that virtual end-effector. As previously noted, the above steps can be performed for each virtual end-effector so as to calculate a friction force for each constrained virtual end-effector.

The device can calculate a gravitational force mg currently exerted on the virtual COM, 520. More specifically, the device can multiply a predetermined mass value m by a predefined gravitational constant g associated with the current virtual world. For example, in some embodiments, the gravitational constant g can be given the value 9.8 m/s² to simulate the gravitational force experienced by objects on Earth.

The device can combine the results of steps 500, 510 and 520 described above to compute a new virtual COM, 530. More specifically, in some embodiments the device can sum the summation of all the spring forces exerted by the virtual end-effectors, the summation of all frictional forces exerted on the constrained virtual end-effectors and the gravitational force to determine a new spatial position of the virtual COM.

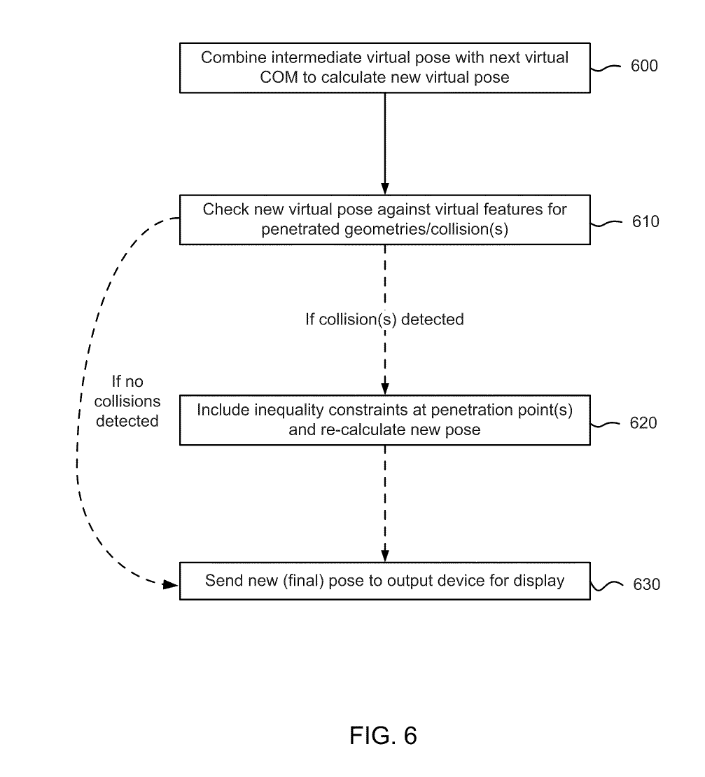

FIG. 6 is a flowchart that illustrates a method for calculating a final pose that avoids penetrated geometries, according to an embodiment. More specifically, FIG. 6 illustrates a series of steps that can be executed by a device to calculate a final virtual pose based at least in part on an intermediate virtual pose, a set of interactive contact points, and a new virtual COM. The virtual pose is calculated so as to ensure that no virtual end-effector point penetrates any geometry of any virtual feature. In some embodiments, each step can be performed by any combination of hardware and/or software, such as one or more computerized devices. Such a device will be discussed for purposes of explanation below.

For purposes of the below discussion of FIG. 6, a possible virtual character simulation method is now defined. In some embodiments, a computerized device can define a virtual character to simulate a real-world actor's body and movement using a center-of-mass and spring model similar to the model described in connection with FIG. 5 above. In such an embodiment, the virtual character pose can be defined by a virtual center-of-mass point and a set of virtual end-effectors that correspond to a set of end-effectors and a spatial center-of-mass point associated with a real-world actor.

A computerized device can combine an intermediate virtual pose with a next virtual center-of-mass (“COM”) to calculate a new virtual pose for a virtual character, 600. In some embodiments, the device can receive or have stored in a memory a set of virtual end-effector positions that define an intermediate virtual pose. In some embodiments, the intermediate virtual pose can be defined based at least in part on a process similar to the intermediate virtual pose calculation method described in connection with FIG. 4 above. In some embodiments, the next virtual COM can be a point in virtual space defined by one or more coordinates, such as spatial coordinates in the form (x, y, z), (r, θ, and φ), etc. In some embodiments, the device can receive or have stored in memory a next virtual COM determined by, for example, a method similar to the virtual COM calculation method described in connection with FIG. 5 above. For example, in some embodiments the device can utilize a standard inverse kinematics approach and couple it with an optimization process to calculate the new virtual pose based on the next virtual COM and the intermediate virtual pose. In some embodiments, the new virtual pose can be defined at least in part by a set of new virtual end-effector positions and the new virtual COM. In some embodiments, the calculation can be bounded, constrained, or otherwise influenced by at a set of interactive contact points associated with the virtual character.

The device can check the new virtual pose for any penetrated geometries and/or collisions, 620. More specifically, in some embodiments, the device can ensure that the position of virtual end-effector defined as defined by the new pose passes through the surface or exterior of a virtual feature of the virtual world in which the character is rendered. For example, in some embodiments, the device can cycle through each virtual end-effector position for each end-effector defined by the new virtual pose and compare that position with a set of contact constraints for one or more virtual features. By virtue of these comparisons, the device can determine if one or more “collisions” occurs, i.e., if any virtual character contact point is currently defined such that it passes “through” the surface of a virtual feature, such as a solid object.

If one or more collisions is detected in step 620, the device can include one or more inequality constraints for each collision/penetration point and re-calculate the new pose, 620. More specifically, in some embodiments the device can receive or have stored in a memory a set of inequality constraints for each virtual feature in the current virtual world. In some embodiments, the device can cycle through each collision detected in step 610 above and insert an inequality constraint associated with the collision point into the new pose calculation discussed in connection with step 600 above. By so doing, the device can modify the initially-calculated new pose to ensure that it conforms to the limitations and bounds of the virtual world, particularly with respect to the world's virtual features.

If no collisions are detected in step 620, or once the new pose has been re-calculated in step 630, the device can send the new and now final pose to an output device for display, 630. More specifically, in some embodiments the device can send the new virtual center-of-mass and virtual end-effector positions of the final pose to an output device for display. For example, upon completion of the above steps, the device can send the final pose information to a screen for display to a user, such as a video game user. In some embodiments, the device can send the final pose information to one or more hardware and/or software modules configured to receive the final pose information and perform further processing thereon. For example, the device can send the final pose information to a software module associated with a video game capable of using the final pose information to render a virtual character within an interactive video game, such as a sports game or adventure game.

As used in this specification, the singular forms “a,” “an” and “the” include plural referents unless the context clearly dictates otherwise. Thus, for example, the term “a module” is intended to mean a single module or a combination of modules.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate.

What is claimed is:

1. A method, comprising:
defining a virtual feature, the virtual feature being associated with at least one engaging condition;
receiving an end-effector coordinate associated with an actor; and
calculating an actor intention based at least in part on a comparison between the at least one engaging condition and the end-effector coordinate.

2. The method of claim 1, wherein the calculating an actor intention further comprises:
defining an example motion associated with the virtual feature; and
comparing the end-effector coordinate to an example end-effector coordinate associated with the example motion.

3. The method of claim 2, wherein the comparing includes comparing a first velocity of an end-effector associated with the end-effector coordinate to a second velocity of an example end-effector associated with the example end-effector coordinate.

4. The method of claim 3, wherein the comparing is based at least in part on a low-dimensional end-effector vector.

5. The method of claim 3, wherein the end-effector coordinate is associated with an unconstrained end-effector.

6. The method of claim 1, further comprising:
assigning an actor intention value if a value associated with the comparing is below a predetermined threshold.

7. The method of claim 1, further comprising:
calculating one or more contact constraints associated with the virtual feature, the contact constraints being based on at least one dimension of the virtual feature.

8. A method, comprising:
defining an example pose, the example pose comprising at least one example end-effector position;
receiving an actor end-effector position;
calculating a virtual pose position based at least in part on the actor end-effector position.

9. The method of claim 8, wherein the calculating is further based at least in part on an interpolation of the example end-effector position and the actor end-effector position.

10. The method of claim 9, wherein the actor end-effector position is a current actor end-effector position and the interpolation is further based at least in part on at least one of:
a difference between the current actor end-effector position and a previous actor end-effector position;
the example pose; and
a direction of actor motion.

11. The method of claim 8, wherein the virtual pose position is a new virtual pose position, the actor end-effector position is associated with a constrained actor end-effector, and a previous virtual end-effector position corresponding to the actor end-effector position is associated with an unconstrained virtual end-effector.

12. The method of claim 8, wherein the virtual pose position is not based at least in part on the at least one example end-effector position if the actor end-effector position is not associated with a constrained actor end-effector.

13. The method of claim 8, wherein the virtual pose position is not based at least in part on the at least one example end-effector position if a previous virtual end-effector position corresponding to the actor end-effector position is not associated with an unconstrained virtual end-effector.

14. A method, comprising:
receiving a virtual character center of mass position (“virtual COM”), an actor center of mass position (“actor COM”), a virtual character end-effector position (“virtual end-effector”), and an actor end-effector position (“actor end-effector”);
calculating a new virtual character center of mass position (“next virtual COM”) based at least in part on one or more of:
a spring force based at least in part on a first relative position of the actor COM and the actor end-effector and a second relative position of the virtual COM and the virtual end-effector; and
a gravitational force compensation value.

15. The method of claim 14, wherein the gravitational force compensation value is evenly distributed across one or more virtual end-effectors associated with the virtual COM.

16. The method of claim 14, further comprising:
calculating an updated virtual character center of mass position (“updated COM”) based at least in part on at least one of:
the next virtual COM; and
a frictional force value based at least in part on a virtual distance between the virtual COM and the next virtual COM.

17. The method of claim 14, wherein the frictional force value is based at least in part on at least one of:
a contact surface type of a virtual feature currently in contact with the virtual end-effector; and
a contact type of the virtual end-effector.

18. The method of claim 14, further comprising:
calculating a new virtual pose based at least in part on the next virtual COM and at least one next virtual end-effector position.

19. The method of claim 18, wherein the calculating minimizes a difference between the new virtual pose and a previous virtual pose.

20. The method of claim 18, further comprising:
detecting a penetrated geometry based at least in part on the at least one next end-effector position and a contact constraint associated with a virtual feature; and
re-calculating the new virtual pose based at least in part on the penetrated geometry and at least one inequality constraint.
